(19) United States
(12) Patent Application Publication
(10) Pub. No.: US 2013/0051373 A1
(43) Pub. Date: Feb. 28, 2013

(54) SIGNAL TRANSMISSION METHOD AND APPARATUS FOR CELL SEARCH IN WIRELESS COMMUNICATION SYSTEM

(71) Applicants: Sangmin RO, Seoul (KR); Joonyoung CHO, Suwon-si (KR); Hyoungju JI, Seoul (KR); Younsun KIM, Seongnam-si (KR)

(72) Inventors: Sangmin RO, Seoul (KR); Joonyoung CHO, Suwon-si (KR); Hyoungju JI, Seoul (KR); Younsun KIM, Seongnam-si (KR)

(73) Assignee: Samsung Electronics Co., Ltd.

(21) Appl. No.: 13/591,904

(22) Filed: Aug. 22, 2012

(30) Foreign Application Priority Data
Aug. 22, 2011 (KR) 10-2011-0083604

(51) Int. Cl. H04W 74/00

(52) U.S. Cl. 370/336

(57) ABSTRACT

Methods and apparatus for transmitting and receiving signals are provided for facilitating a cell search in a wireless communication system supporting various types of multicarrier transmission. A carrier type indication signal indicating a type of carrier supported by the base station is generated. The carrier type indication signal is transmitted with synchronization signals, to one or more terminals in a cell of the base station. A type of a carrier supported by a base station is determined based on a carrier type indication signal transmitted by the base station. A cell search procedure is performed to access the base station according to the type of the carrier supported by the base station.

### PRIORITY

This application claims priority under 35 U.S.C. §119(a) to an application filed in the Korean Intellectual Property Office on Aug. 22, 2011, and assigned serial No. 10-2011-0083604, the contents of which are incorporated herein by reference.

### BACKGROUND OF THE INVENTION

1. Field of the Invention

The present invention relates generally to a wireless communication system and more particularly, to a method and an apparatus for transmitting and receiving signals that facilitate cell search in a wireless communication system supporting various types of multicarrier transmission.

2. Description of the Related Art

Wireless communication systems evolve continuously to improve service quality. For example, the Long Term Evolution (LTE) standard of the 3^{rd} Generation Partnership Project (3GPP) has evolved to a version of release 10, which adopts Carrier Aggregation (CA) through releases 8 and 9. Release 11 is expected to discuss support of different types of carriers. The different types of carriers may include, for example, a Backward Compatible Carrier (BCC) that allows for legacy system User Equipments (UEs) and evolved system UEs, as well as a Non-Backward Compatible Carrier (NBCC) that allows for only the evolved system UEs.

If the NBCC is introduced as a new carrier type as the LTE system evolves, a UE must conduct an NBCC cell search and a BCC cell search. Particularly, when the UE that supports the NBCC operates on a single carrier for data communication, it has to connect to the NBCC cell directly as well as the BCC cell and, as a consequence, the NBCC cell search is inevitable. The NBCC-enabled UE is currently unable to discriminate between the carrier types, i.e. BCC and NBCC, of the current cell in the cell search process. Therefore, the UE must perform both BCC synchronization signal detection and cell search and NBCC synchronization single detection and cell search, which results in cell search complexity.

### SUMMARY OF THE INVENTION

The present invention has been made to address at least the above problems and/or disadvantages and to provide at least the advantages below. Accordingly, an aspect of the present invention provides a cell search method and an apparatus of a UE that are capable of reducing cell search complexity in a wireless communication system supporting multiple types of carriers.

Another aspect of the present invention provides a cell search method and apparatus that is capable of facilitating a cell search procedure of the UEs in the system supporting the new carrier type as well as the legacy carrier, by designing a new carrier type synchronization signal, such that the legacy UE cannot access the new carrier type.

In accordance with an aspect of the present invention, a signal transmission method of a base station in a wireless communication system is provided. A carrier type indication signal indicating a type of carrier supported by the base station is generated. The carrier type indication signal is transmitted with synchronization signals, to one or more terminals in a cell of the base station, for use by the one or more terminals in a cell search procedure to access the base station.

In accordance with another aspect of the present invention, a signal reception method of a terminal in a wireless communication system is provided. A type of a carrier supported by a base station is determined based on a carrier type indication signal transmitted by the base station. A cell search procedure is performed to access the base station according to the type of the carrier supported by the base station.

In accordance with another aspect of the present invention, a signal transmission apparatus of a base station in a wireless communication system is provided. The apparatus includes an indication signal generator that generates a carrier type indication signal to indicate a type of a carrier supported by the base station. The apparatus also includes a synchronization signal generator that generates synchronization signals for use in a cell search procedure of a terminal to access the base station according to the type of the carrier. The apparatus further includes a controller that controls transmission of the carrier type indication signal and the synchronization signals to the terminal within a cell of the base station.

In accordance with still another aspect of the present invention, a signal reception apparatus of a terminal in a wireless communication system is provided. The apparatus includes an indication signal detector that determines a type of a carrier supported by a base station, when a carrier type indication signal transmitted by the base station is detected. The apparatus also includes a cell search controller that performs a cell search procedure to access the base station according to the type of the carrier supported by the base station.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a structure of a cell search-related signal for use in a cell search method of a wireless communication system;

FIG. 2 is a signaling diagram illustrating a cell search method between an evolved Node B (eNB) and a UE in the wireless communication system, according to an embodiment of the present invention;

FIG. 3 is a diagram illustrating a structure of the cell search-related signal for use in the cell search method, according to an embodiment of the present invention;

FIG. 4 is a diagram illustrating a structure of the cell search-related signal for use in the cell search method, according to another embodiment of the present invention;

FIG. 5 is a diagram illustrating a configuration of an NBCC synchronization signal for use in the cell search method for the wireless communication system, according to an embodiment of the present invention;

FIG. 6 is a block diagram illustrating a configuration of a transmitter of the eNB, according to an embodiment of the present invention;

FIG. 7 is a block diagram illustrating a configuration of a receiver of the UE, according to an embodiment of the present invention;

FIG. 8 is a flowchart illustrating the cell search method at the eNB in the wireless communication system, according to an embodiment of the present invention; and

FIG. 9 is a flowchart illustrating the cell search method at the UE in the wireless communication system, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention. Further, the following terms are defined in consideration of the functionality in the present invention, and may vary according to the intention of a user or an operator, usage, etc. Therefore, the definition should be made on the basis of the overall content of the present specification.

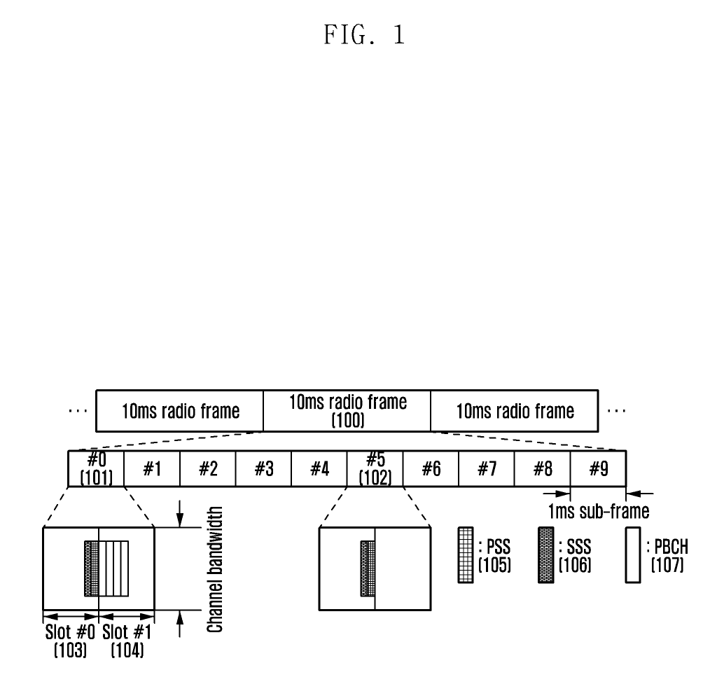

FIG. 1 is a diagram illustrating the structure of the cell search-related signal for use in the cell search procedure of a wireless communication system.

Referring to FIG. 1, the eNB transmits the signal for the UE's access at a 0^{th} subframe 101 and a 5^{th} subframe 102 of a radio frame 100 of 10 milliseconds (ms). Each subframe spans 1 ms and consists of two 0.5 ms slots, slot #0 103 and slot #1 104. Each slot consists of 7 OFDM symbols (#0, #1, . . . , #5, #6). The UE receives a Primary Synchronization Signal (PSS) to acquire the symbol timing and cell ID-related information (N_{ID}⁽²⁾). The PSS is transmitted at the last OFDM symbol (#6) of the slot #0 103 of the 0^{th} and 5^{th} subframes. The PSS occupies 6 Resource Blocks (RBs) at the center of the system channel band in a frequency domain of the corresponding OFDM symbol. One RB consists of 12 subcarriers, and 6 RBs correspond to 72 subcarriers or, by taking notice of the Direct Current (DC) subcarrier at the cell of the channel band, total 73 subcarriers. The 5 subcarriers at each of both boundaries and the DC subcarrier at the center of the of the channel band do not carry a signal, and the PSS is carried across the rest of the 62 subcarriers in the form of a Zadoff-Chu (ZC) sequence.

After PSS detection, the UE detects a Secondary Synchronization Signal (SSS) 106 to acquire the radio frame synchronization and cell ID group-related information (N_{ID}⁽¹⁾). The SSS is carried at the second from last OFDM symbol in the same slot as the PSS. The SSS occupies the 73 subcarriers as the center of the channel band (6 RBs and DC subcarrier). The SSS consists of two short sequences based on an M-sequence, and the length of each short sequence is 31. Like the PSS, the SSS occupies 6 RBs and a 73 subcarrier region, including the DC subcarrier, and is transmitted in the form of two alternated short sequences having a length of 31. Specifically, one short sequence is mapped to the even numbered subcarrier, and the other short sequence is mapped to the odd numbered subcarrier.

Once the primary and secondary synchronization signals have been detected, the UE acquires an ID of the corresponding cell, as well as the symbol and radio frame timings, as shown in Equation (1) below.

N_{ID}^{cell}=3N_{ID}⁽¹⁾+N_{ID}⁽²⁾| (1)

N_{ID}^{cell} denotes the cell ID, N_{ID}⁽¹⁾ denotes the cell ID group index acquired from the SSS, and N_{ID}⁽²⁾ denotes the cell ID-related information in the cell ID group acquired from the PSS. N_{ID}⁽¹⁾ is in the range of 0˜167, and N_{ID}⁽²⁾ is in the range of 0˜2, so that a total of 168×3=504 cell IDs are able to be expressed. Once the timings and cell ID have been acquired through the above process, the UE connects to the corresponding cell eNB to receive system information, such as, for example, downlink system channel bandwidth, System Frame Number (SFN), Physical HARQ Indicator Channel (PHICH) resource, and symbol duration information. The above information is included in a Physical Broadcast Channel (PBCH) 107, which is broadcast by the eNB in the cell. The corresponding channel is scrambled with a sequence selected depending on the cell ID. The PBCH 107 is transmitted on the 6 RBs frequency region at the center of the channel band for the first 4 OFDM symbols, duration of the slot #1 104 of the 0^{th} subframe (#0), as shown in FIG. 1.

In the legacy wireless communication system, the cell search procedure is performed as described above. The introduction of NBCC as a new type of carrier makes it necessary for the NBCC-enabled UE to support the cell search procedure for NBCC as well as the above-described cell search procedure for the legacy Backward Compatible Carrier (BCC). Since the NBCC-enabled UE operating on a single carrier is required to access the NBCC cell as well as the BCC cell, it is necessary for the NBCC-enabled UE to support NBCC cell search. When the NBCC-enabled UE cannot discriminate between the BCC and NBCC, it is required to perform a signal detection and cell search procedure for both the BCC and NBCC, resulting in cell search complexity.

A new NBCC synchronization signal, discriminated from the legacy BCC synchronization signal, is defined in order for the legacy release UE to perform the cell search on the BCC, but not the NBCC.

Embodiments of the present invention provide a method and an apparatus for reducing the cell search complexity in the wireless communication system supporting multiple types of carriers.

Hereinafter, a description is made of the method for transmitting a carrier type indication signal in the wireless communication system supporting multiple types of carriers.

In an embodiment of the present invention, the UE determines whether the carrier type indication signal is received from the eNB so as to perform the NBCC cell search procedure when the carrier type indication is received, and to perform the BCC cell search procedure when no carrier type indication is received. If it is determined that the carrier type indicator is received, the UE performs the NBCC cell search procedure first and, the NBCC cell search fails, the UE performs the BCC cell search.

In an embodiment of the present invention, the carrier type indication signal is transmitted at the center frequency region of the channel band in the last OFDM symbol of the subframe carrying the cell search-related signals. The carrier type indication signal can be transmitted through a subcarrier that is not used in the OFDM symbol carrying the synchronization signal.

In order to discriminate between the NBCC synchronization signal and the BCC synchronization signal, an embodiment of the present invention sets the root sequence index of the NBCC PSS sequence to a value that is different from that of the root sequence index of the PSS sequence of a BCC synchronization signal. The mapping of the SSS sequence, as one of BCC synchronization signals, to the subcarriers is configured to be different from the mapping of the NBCC SSS sequence to the subcarriers. The above described synchronization design method can be applied to the NBCC synchronization signal in various manners. Specifically, the PSS can be designed as described above while the SSS is used as in the conventional BCC, or both the PSS and SSS can be designed as described above. When the carrier type indication signal is not used, the UE has to perform both the NBCC and BCC cell search procedures to select a cell. In this case, the PSS detection complexity of the UE becomes 2 (NBCC and BCC)×3 (three PSS sequences)=6. However the detection complexity drops down to 1 (carrier type indication signal detection)+1 (NBCC or BCC)×3 (three types of PSS sequence)=4 by using the carrier type indication signal. Since the carrier type indication signal includes no cell ID information, it is possible for all NBCC cells to transmit the same signal on the same time/frequency resource.

To differentiate the NBCC cell search procedure from the BCC cell search procedure, other methods besides the method to use different synchronization signals, can be implemented. For example, PBCH positions can be differentiated using the same PSS/SSS synchronization signals. In such a case, by utilizing the carrier type indication signal, reducing the cell search complexity can be achieved. Specifically, reducing the cell search complexity can be achieved by using the carrier type indication signal when the NBCC cell search procedure is designed to be differentiated from the BCC cell search procedure.

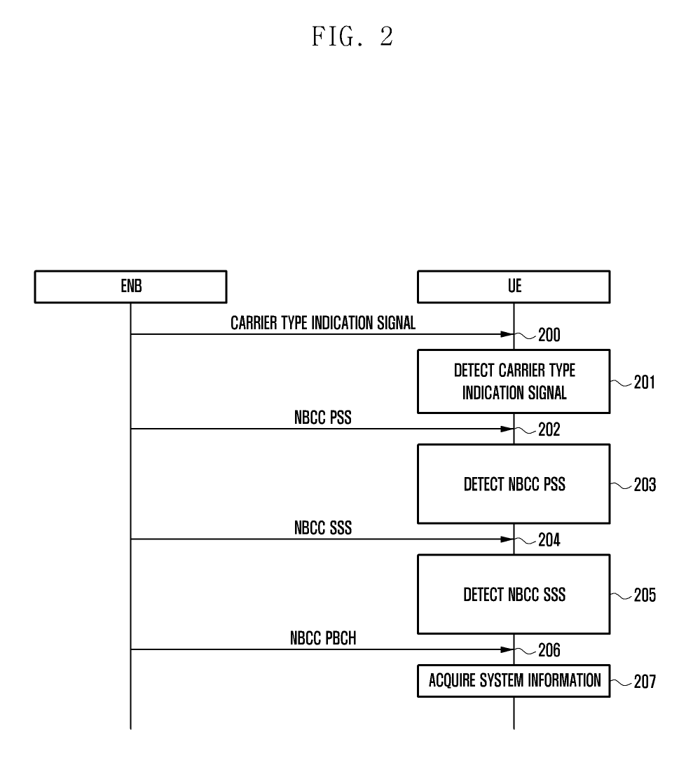

FIG. 2 is a signaling diagram illustrating a cell search method between an eNB and a UE in the wireless communication system, according to an embodiment of the present invention.

Referring to FIG. 2, the NBCC eNB broadcasts the carrier type indication system to notify the UEs within the cell that it operates on the NBCC, in step 200. The UE receives the carrier type indication signal, in step 201, and acquires the time synchronization and carrier type information. The carrier type indication signal is carried by the synchronization signals as the cell search-related signals, i.e., at a resource location predetermined in a subframe carrying the NBCC PSS and NBCC SSS. After the carrier type indication signal is successfully received by the UE, the eNB transmits the NBCC PSS, in step 202. The UE receives the NBCC PSS, in step 203, and acquires OFDM symbol synchronization and cell ID information (N_{ID}⁽²⁾). The eNB transmits the NBCC SSS, in step 204. The UE receives the NBCC SSS, in step 205, to acquire radio frame synchronization and cell ID group information (N_{ID}⁽¹⁾). After the time synchronization and cell ID are acquired by the UE, the eNB transmits the PBCH, in step 206. The UE receives the PBCH, in step 207. If UE fails to receive the carrier type indication signal in step 200, the UE performs the BCC cell search procedure to receive the BCC PSS and SSS synchronization signals.

Unlike the method of performing both the NBCC cell search and BCC cell search procedures, the cell search method, according to an embodiment of the present invention, operates in such a way that the UE selects one of the two different cell search procedures depending on whether the carrier type indication signal is received from the eNB.

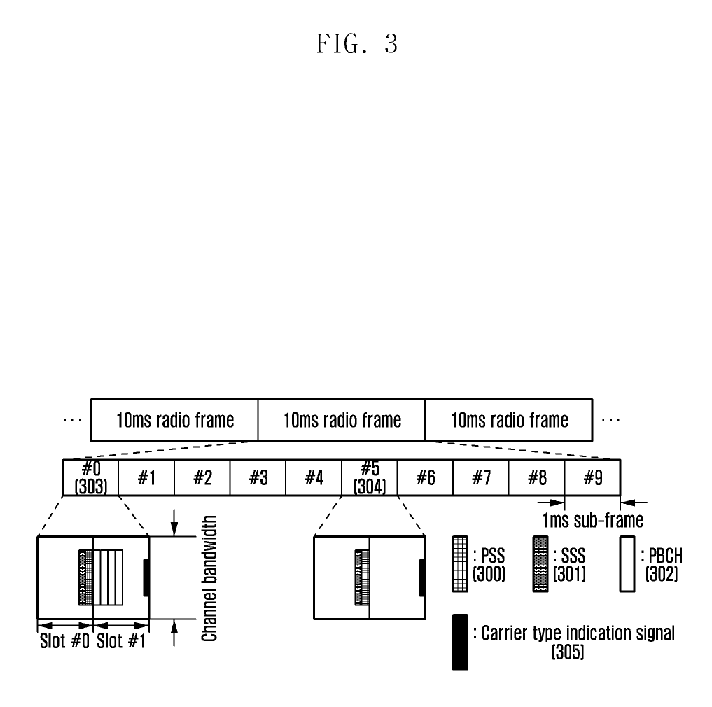

FIG. 3 is a diagram illustrating a structure of the cell search-related signal for use in the cell search method, according to an embodiment of the present invention. Particularly, FIG. 3 is directed to an embodiment in which the eNB transmits the carrier type indication signal in the last OFDM symbol of the subframe carrying the cell search-related signal.

Referring to FIG. 3, the eNB transmits a carrier type indication signal 305 using the subcarriers at the center of the channel band in the frequency domain in the last OFDM symbol of a 0^{th} subframe 303 and a 5^{th} subframe 304 carrying a PBCH 302, and including a PSS 300 and an SSS 301 as the cell search-related signals. The number of subcarriers used for the carrier type indicator signal transmission at the last OFDM symbol, i.e., the sequence length, can be determined within a predetermined range capable of guaranteeing reliability of the carrier type indication signal at the receiver of the UE in the region corresponding to the 6 RBs at the center of the channel band. In order to prevent the carrier type indication signal from being interfered with by other signals, the subcarriers that are not used for the carrier type indication signal transmission in the 6 RBs region at the center of the last OFDM symbol are not used for other signal transmission.

In the LTE system, since the cell search-related signals are mapped to the frequency resource of 6 RBs at the center of the channel band of some OFDM symbols of the 0^{th} and 5^{th} subframes, the probability for which the downlink data is mapped to the frequency resource of the 6 RBs at the center of the channel band in these subframes is very low, as long as the neighbor BCC cell is not overloaded. Thus, the probability of the interference by the downlink data transmitted in the neighbor BCC cell is also low, and it is advantageous to transmit the carrier type indication signal in these subframes. By taking notice of a situation where downlink data of the neighbor BCC cell is mapped to the same location as the carrier type indication signal due to overload, it is preferred to increase the number of samples (subcarriers) for the carrier type indication signal transmission to improve the reception reliability at the reception end of the UE.

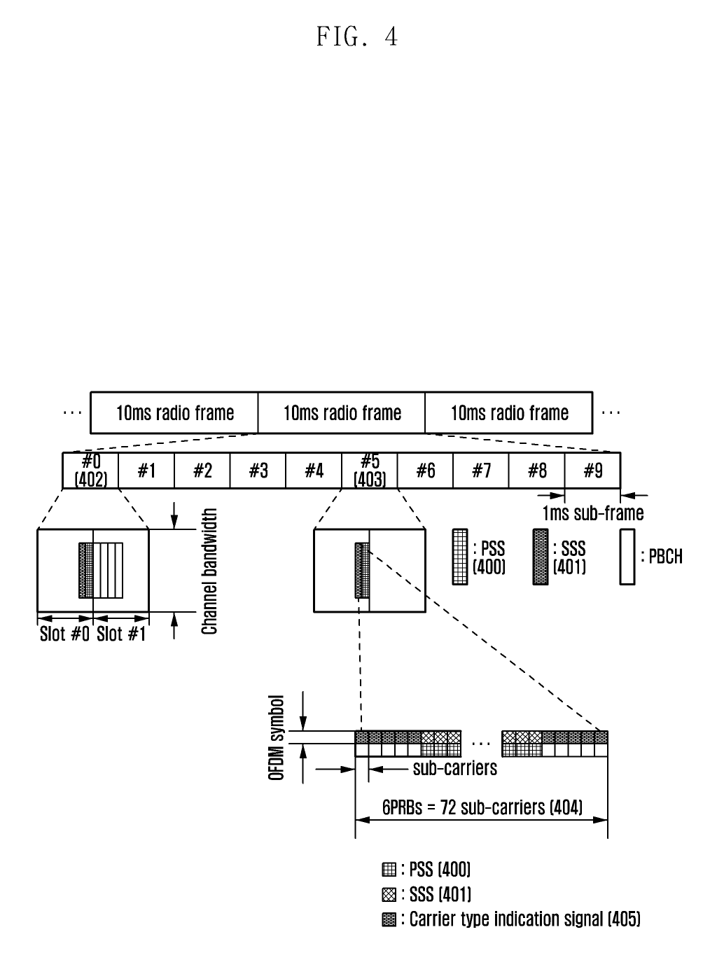

FIG. 4 is a diagram illustrating a structure of the cell search-related signal for use in the cell search method, according to another embodiment of the present invention. FIG. 4 is directed to an embodiment in which the carrier type indication signal is transmitted in the subcarriers that are not used for other signal transmission at the OFDM symbols carrying the synchronization signals.

Referring to FIG. 4, the carrier type indication signal is mapped to the resource on which the SSS is transmitted at a 0^{th} subframe 402 and a 5^{th} subframe 403 carrying a PSS 400 and an SSS 401 as the cell search-related signals. In the frequency domain, a carrier type indication signal 405 is transmitted on the subcarriers empty at both sides of 6 RBs 404 at the center of the channel band of the OFDM symbols carrying the SSS.

Since the subcarriers that remained empty at both sides of the 6 RBs of the center of the channel band of the OFDM symbols carrying the SSS carry no other signals even in the neighbor BCC cell, it is advantageous in that there is no interference caused by the downlink data of the neighbor cell when the UE receives the carrier type indication signal. Thus, the UE can receive the carrier type indication signal after acquiring the time synchronization based on the PSS.

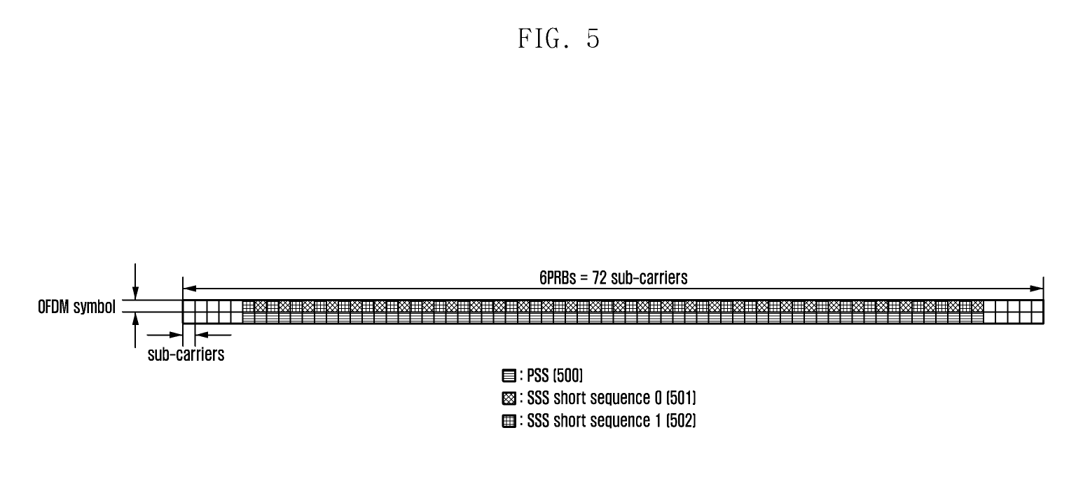

FIG. 5 is a diagram illustrating a configuration of the NBCC synchronization signal for use in the cell search method for the wireless communication system, according to an embodiment of the present invention.

Referring to FIG. 5, an NBCC PSS 500 is transmitted through the region corresponding to the 62 subcarriers at the center of the channel band at the last OFDM symbol of the 0^{th} slots of 0^{th} and 5^{th} subframes, in the form of a ZC sequence as expressed by Equation (2) below.

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad ( 2 )$$

dᵤ(n) is the n^{th} value of the ZC sequence, and u denotes the root sequence index value of the ZC sequence. The ZC sequence is carried, as the PSS, by 31 subcarriers at each of left (n=0, 1, . . . , 30) and right (n=31, 32, . . . , 61) sides judged by the channel band center DC subcarrier. The NBCC PSS sequence is generated using a root sequence index u of a ZC sequence other than the BCC PSS sequence. Specifically, the root sequence index value u of the ZC sequence that is used for generating the PSS sequence can have one of three values. If the value u used for generating the BCC PSS sequence is configured as u₁, u₂, and u₃, the value u to be used in generating the NBCC PSS is configured differently as u₁′, u₂′, and u₃′. The NBCC PSS sequence and BCC PSS sequence generated as described above have a low correlation.

Meanwhile, the NBCC SSS occupies the regions corresponding to 62 subcarriers at the center of the channel band at the second from last OFDM symbol of the same slot of the same subframes as the NBCC PSS, and is transmitted in a form in which the M-sequence-based two short sequences are alternately interleaved to respective even numbered subcarriers 501 and odd numbered subcarrier 502 as expressed in Equation (3) below.

$$d ( 2 n + 1 ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix} \qquad ( 3 )$$

d denotes 62 subcarriers transmission signal with the exception of the subcarriers not used at both sides of the 6 RBs at the center of the channel band, and n denotes a rand from 0 to 30. S₀^{(m0)} and S₁^{(m1)} denote short M-sequences s₀ and s₁ having a length of 31, m₀ and m₁ denote cyclic shift values of the M-sequences s₀ and s₁ that are determined by the cell ID group information (N_{ID}⁽¹⁾). c₀ and c₁ denote M-sequence-based scrambling sequences and are determined by the cell ID information (N_{ID}⁽²⁾). z₁^{(m0)} and z₁^{(m1)} denote M-sequence-based scrambling sequences to which the cyclic shift values m0 and m1 are applied and then multiplied to the even-numbered subcarrier signals.

The NBCC SS uses the same sequence generation procedure as the BCC SSS, except the mapping of the generated two short sequences to the subcarriers differs from that for the BCC SSS. Specifically, the signals d(2n) transmitted on the even-numbered subcarriers are transmitted on the odd-numbered subcarriers for the BCC SSS, while the signals d(2n+1) transmitted on the odd-numbered subcarriers are transmitted on the even-numbered subcarriers for the BCC SSS. Although the description is directed to an embodiment in which the NBCC SSS and BCC SSS are mapped to the odd and even numbered subcarriers differently, it is also possible to map the signals differently at the 0^{th} and 5^{th} subframes. Specifically, the NBCC SSS is generated differently and mapped to subcarriers different from those of the BCC according to the subframe index and whether the subcarriers transmitted at the subframe are odd-numbered or even-numbered.

As described above, the NBCC PSS and SSS designed according to an embodiment of the present invention are capable of preventing the UE supporting only the BCC from attempting reception of the NBCC synchronization signal, without compromising the PCC PSS and SSS generation procedures.

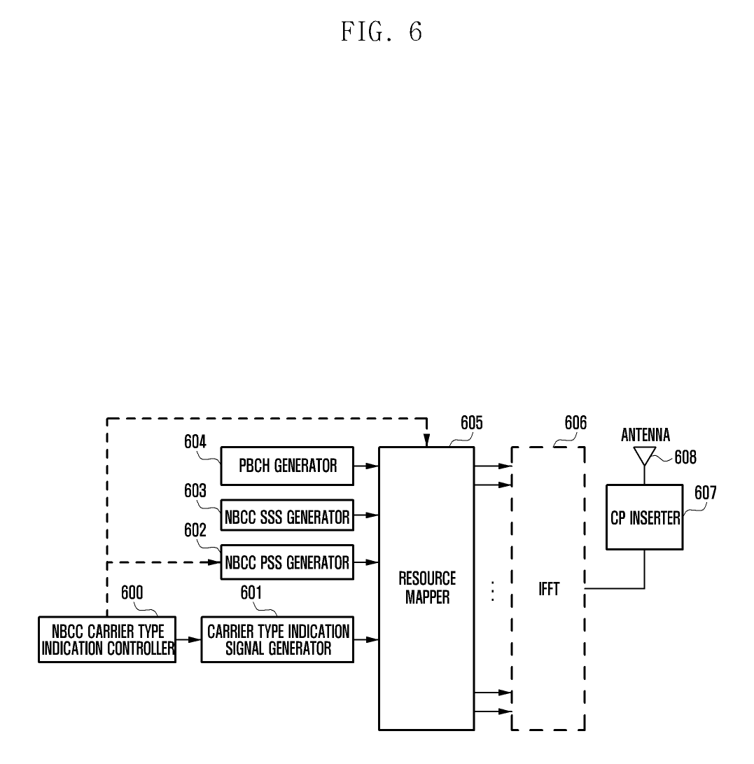

FIG. 6 is a block diagram illustrating a configuration of a transmitter of the eNB, according to an embodiment of the present invention.

Referring to FIG. 6, the eNB includes a carrier type indication controller 600, a carrier type indication signal generator 601, an NBCC PSS generator 602, an NBCC SSS generator 603, a PBCH generator 604, a resource mapper 605, an Inverse Fast Fourier Transformer (IFFT) 606, a Cyclic Prefix (CP) inserter 607, and an antenna 608. The carrier type indication controller 600 controls the eNB to generate the NBCC cell search-related signals and allocate a resource at the 0^{th} and 5^{th} subframes, according to an embodiment of the present invention. The carrier type indication signal generator 601 generates the eNB-supportable carrier type indication signal, i.e., the carrier type indication signal indicating the NBCC, under the control of the carrier type indication controller 600. The NBCC PSS generator 602 generates the NBCC PSS under the control of the carrier type indication controller 600. The NBCC SSS generator 603 generates the NBCC SSS. The PBCH generator 604 generates the PBCH as the system information of the eNB. However, the PBCH is generated for the 0^{th} subframe, but not the 5^{th} subframe. The resource mapper 605 maps the carrier type indication signal, NBCC PSS, NBCC SSS, and PBCH to the resource of the predetermined subframes. The resource mapper 605 maps the carrier type indication signal to the center of the channel band at the last OFDM symbol of the 0^{th} and 5^{th} subframes, according to an embodiment of the present invention. The resource mapper 605 also maps the short sequences of the NBCC SSS to the even-numbered and odd-numbered subcarriers. The resource mapper 605 also maps the NBCC PSS and PBCH to the appropriate resources. The IFFT 606 converts the signal to the time domain signal. The CP inserter 607 inserts a CP to the converted signal, such that the CP inserted signal is transmitted through the antenna 608.

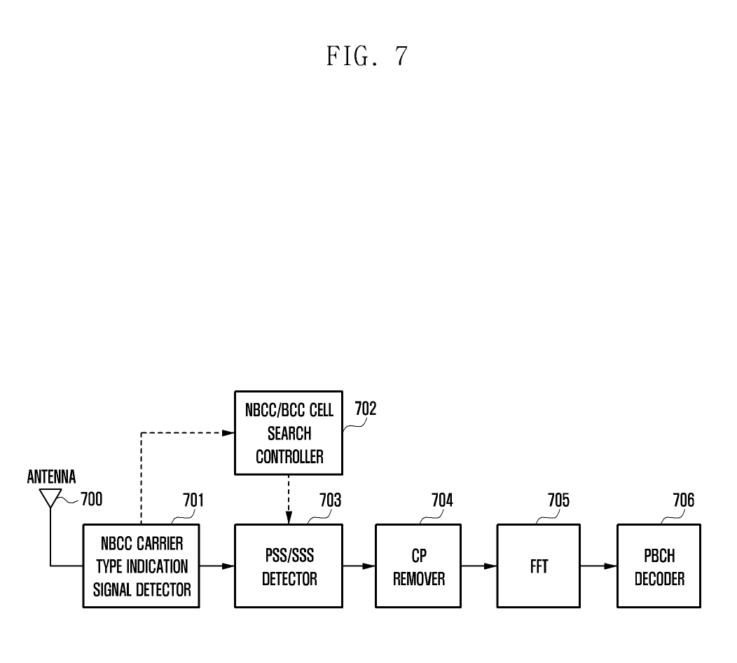

FIG. 7 is a block diagram illustrating a configuration of the receiver of the UE, according to an embodiment of the present invention.

As shown in FIG. 7, the UE includes an antenna 700, a carrier type indication signal detector 701, a NBCC/BCC cell search controller 702, a PSS/SSS detector 703, a CP remover 704, a Fast Fourier Transformer (FFT) 705, and a PBCH decoder 706.

The antenna receives the signal transmitted by the eNB at the antenna 700. The carrier type indication signal detector 701 detects the carrier type indication signal, according to an embodiment of the present invention. The carrier type indicator signal detector 701 detects the carrier type indication signal at a predetermined resource location. The carrier type indication signal detector 701 is capable of determining the carrier type supported by the eNB according to the carrier type indication detection result. The NBCC/BCC cell search controller 702 determines whether to perform the NBCC cell search procedure or the BCC cell search procedure according to the carrier type supported by the eNB, and controls the PSS/SSS detection operation based on the determined cell search procedure. The PSS/SSS detector 703 performs the NBCC or BCC cell search procedure to detect the PSS/SSS under the control of the NBCC/BCC cell search controller 702. The PSS/SSS detector 703 also acquires time synchronization and a cell ID through the carrier type indication signal and synchronization signal detection procedure. The CP remover 704, the FFT 705, and the PBCH decoder 706 operate to acquire the system information of the eNB.

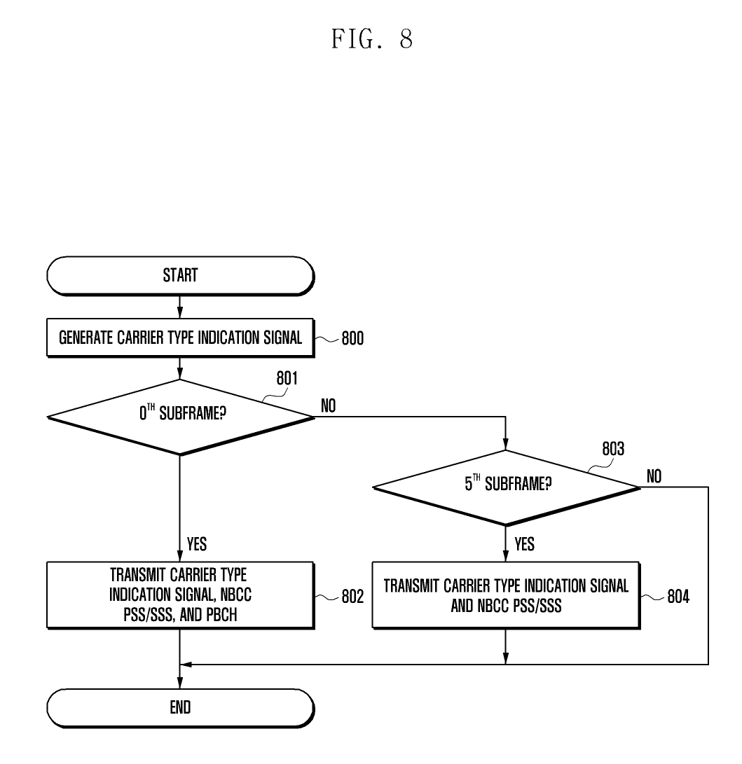

FIG. 8 is a flowchart illustrating the cell search method at the eNB in the wireless communication system, according to an embodiment of the present invention. It is assumed that the transmission timing of the eNB is the 0^{th} or 5^{th} subframe carrying the cell search-related signals.

Referring to FIG. 8, the eNB generates the carrier type indication signal indicating the carrier type supported by the eNB, in step 800. The eNB determines whether the current subframe is the 0^{th} subframe, in step 801. If the current subframe is the 0^{th} subframe, the eNB transmits the NBCC PSS/SSS and PBCH including the carrier type indication signal, in step 802. If the current subframe is not the 0^{th} subframe, the eNB determines whether the current subframe is the 5^{th} subframe, in step 803. If the current subframe is the 5^{th} subframe, the eNB transmits the carrier type indication signal and NBCC PSS/SSS, in step 804.

The eNB transmits the carrier type indication signal through a predetermined resource location at the 0^{th} and 5^{th} subframes in the form of a sequence. The eNB is capable of transmitting the NBCC PSS generated according to the root sequence index, which is different from that of the BCC PSSS. The eNB generates the NBCC SSS having a different value according to the subframe index, and maps the NBCC SSS to subcarriers that are different from those of the BCC SSS. The eNB also can generate the NBCC SSS having a different value, according to whether the indices of the subcarriers for transmission at the subframes are odd numbers or even numbers, and map the signals to the subcarriers that are different from those of the BCC SSS.

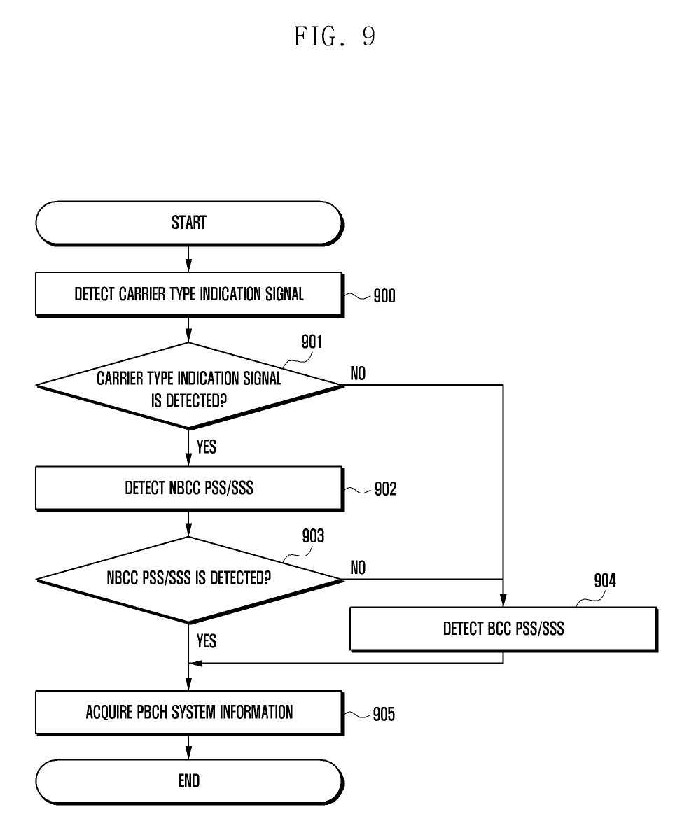

FIG. 9 is a flowchart illustrating the cell search method at the UE in the wireless communication system, according to an embodiment of the present invention.

Referring to FIG. 9, the UE attempts detection of the carrier type indication signal transmitted by the eNB, in step 900. The UE determines whether the carrier type indication signal is transmitted at a predetermined resource location at the 0^{th} or 5^{th} subframe. The UE determines whether the carrier type indication signal is detected, in step 901. The UE checks the carrier type supported by the eNB based on the carrier type indication signal, and performs a cell selection procedure selected according to the carrier type.

If the carrier type indication signal is detected, the UE performs NBCC PSS/SSS detection, in step 902. The NBCC PSS is generated with a root sequence index that is different from that of the BCC PSS. The NBCC SSS is generated with a different value according to the subframe index and mapped to subcarriers that are different from those of the BCC SSS. The NBCC SSS is also generated with a different value, according to whether the indices of the subcarriers to be transmitted at the subframe are odd-numbered or even-numbered, and mapped to subcarriers that are different from those of the BCC SSS. The UE determines whether the NBCC PSS/SSS is detected successfully, in step 903. If the NBCC PSS/SSS is detected successfully, the UE analyzes the NBCC PSS/SSS to acquire the system information from the PBCH, in step 905. If the carrier type indication signal is not detected in step 901 or the NBCC PSS/SSS is not detected at step 903, the UE performs BCC PSS/SSS detection, in step 904, and analyzes the BCC PSS/SSS to acquire the system information from the PBCH at step 905.

Although the above-described embodiments of the present invention are directed to a case where the NBCC eNB transmits the carrier type indication signal such that the UE can discriminate the NBCC eNB from the BCC eNB, the embodiments of the present invention is not limited thereto. Specifically, the present invention can be implemented in such a way that the BCC eNB transmits a carrier type indication signal different from that transmitted by the NBCC eNB, such that the UE can discriminate between BCC and NBCC eNBs. If the carrier type indication signal is received from the NBCC eNB, the UE is capable of detecting the NBCC PSS/SSS to receive the PBCH. Otherwise, if the carrier type indication signal is received from the BCC eNB, the UE is capable of detecting the BCC PSS/SSS to receive the PBCH.

As described above, the cell search method and apparatus of embodiments of the present invention is characterized in that the eNB transmits the carrier type indication signal such that the UE determines whether to perform the NBCC cell search procedure or the BCC cell search procedure, depending on whether the carrier type indication signal is detected. The cell search method and apparatus of the present invention is capable of reducing the cell search complexity in the wireless communication system supporting multiple types of carriers as compared to the case whether all available multiple types of cell search procedures are performed.

While the invention has been shown and described with reference to certain embodiments thereof, it will be understood by those skilled in the art that various changes in form and detail may be made therein without departing from the spirit and scope of the present invention, as defined in the appended claims.

What is claimed is:

1. A signal transmission method of a base station in a wireless communication system, the method comprising the steps of:
generating a carrier type indication signal indicating a type of carrier supported by the base station; and
transmitting the carrier type indication signal with synchronization signals, to one or more terminals in a cell of the base station, for use by the one or more terminals in a cell search procedure to access the base station.

2. The signal transmission method of claim 1, wherein transmitting the carrier type indication signal with the synchronization signals comprises transmitting the carrier type indication signal in a predetermined resource location in a subframe carrying the synchronization signals in the form of a sequence.

3. The signal transmission method of claim 1, wherein transmitting the carrier type indication signal with the synchronization signals comprises:
generating one of the synchronization signals differently, according to an index of the subframe or according to whether indices of subcarriers for transmission in the subframe are odd-numbered or even-numbered; and
mapping the differently generated synchronization signal to subcarriers that are different from subcarriers to which other synchronization signals, transmitted by a different base station supporting a different carrier type, are mapped.

4. The signal transmission method of claim 2, wherein transmitting the carrier type indication signal with the synchronization signals comprises generating one of the synchronization signals with a root sequence index that is different from a root sequence index of another synchronization signal transmitted by a different base station supporting a different carrier type.

5. A signal reception method of a terminal in a wireless communication system, the method comprising the steps of:
determining a type of a carrier supported by a base station based on a carrier type indication signal transmitted by the base station; and
performing a cell search procedure to access the base station according to the type of the carrier supported by the base station.

6. The signal reception method of claim 5, further comprising determining whether the carrier type indication signal is detected in a predetermined resource location.

7. The signal reception method of claim 5, wherein performing the cell search procedure comprises:
determining whether synchronization signals transmitted according to the type of carrier are detected;
searching for a cell by analyzing the synchronization signals, when the synchronization signals are detected; and
receiving system information transmitted by the base station in the cell.

8. The signal reception method of claim 7, wherein performing the cell search procedure comprises searching for the cell by analyzing other synchronization signals transmitted according to another type of carrier, when the synchronization signals are not detected.

9. The signal reception method of claim 7, wherein one of the synchronization signals is generated differently according to an index of a subframe or according to whether indices of subcarriers for transmission in the subframe are odd-numbered or even-numbered, and wherein the differently generated synchronization signal is mapped to subcarriers that are different from subcarriers to which other synchronization signals, transmitted by a different base station supporting a different carrier type, are mapped.

10. The signal reception method of claim 7, wherein one of the synchronization signals is generated with a root sequence index that is different from a root sequence index of another synchronization signal transmitted by a different base station supporting a different carrier type.

11. A signal transmission apparatus of a base station in a wireless communication system, comprising:
an indication signal generator that generates a carrier type indication signal to indicate a type of a carrier supported by the base station;
a synchronization signal generator that generates synchronization signals for use in a cell search procedure of a terminal to access the base station according to the type of the carrier; and
a controller that controls transmission of the carrier type indication signal and the synchronization signals to the terminal within a cell of the base station.

12. The signal transmission apparatus of claim 11, wherein the controller controls transmission of the carrier type indication signal in a predetermined resource location in a subframe carrying the synchronization signals in the form of a sequence.

13. The signal transmission apparatus of claim 12, wherein the controller controls generation of one of the synchronization signals differently, according to an index of the subframe or according to whether indices of subcarriers for transmission in the subframe are odd-numbered or even-numbered, and wherein the differently generated synchronization signal is mapped to subcarriers that are different from subcarriers to which other synchronization signals, transmitted by a different base station supporting a different carrier type, are mapped.

14. The signal transmission apparatus of claim 12, wherein the controller controls generation of one of the synchronization signals with a root sequence index that is different from a root sequence index of another synchronization signal transmitted by a different base station supporting a different carrier type.

15. A signal reception apparatus of a terminal in a wireless communication system, comprising:
an indication signal detector that determines a type of a carrier supported by a base station, when a carrier type indication signal transmitted by the base station is detected; and
a cell search controller that performs a cell search procedure to access the base station according to the type of the carrier supported by the base station.

16. The signal reception apparatus of claim 15, wherein the indication signal detector determines whether the carrier type indication signal is detected in a predetermined resource location.

17. The signal reception apparatus of claim 15, wherein the cell search controller controls determining whether synchronization signals transmitted according to the type of carrier are detected, searching for a cell by analyzing the synchronization signals when the synchronization signals are detected, and receiving system information transmitted by the base station in the cell.

18. The signal reception apparatus of claim 17, wherein the cell search controller controls searching for the cell by analyzing other synchronization signals transmitted according to another type of carrier, when the synchronization signals are not detected.

19. The signal reception apparatus of claim 17, wherein one of the synchronization signals is generated differently according to an index of a subframe or according to whether indices of subcarriers for transmission in the subframe are odd-numbered or even-numbered, and wherein the differently generated synchronization signal is mapped to subcarriers that are different from subcarriers to which other synchronization signals, transmitted by a different base station supporting a different carrier type, are mapped.

20. The signal reception apparatus of claim 17, wherein one of the synchronization signals is generated with a root sequence index that is different from a root sequence index of another synchronization signal transmitted by a different base station supporting a different carrier type.
